(19) United States
(12) Patent Application Publication
(10) Pub. No.: US 2011/0044716 A1
(43) Pub. Date: Feb. 24, 2011

(54) METHOD OF CONTROLLING IMAGE FORMING APPARATUS SUPPORTING GLOSSY PRINTING IN HOST DEVICE, AND THE HOST DEVICE AND THE IMAGE FORMING APPARATUS PERFORMING THE METHOD

(75) Inventors: In-Sung CHOI, Seoul (KR); Young-Ju Kim, Suwon-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 12/860,580

(22) Filed: Aug. 20, 2010

(30) Foreign Application Priority Data
Aug. 21, 2009 (KR) 10-2009-0077870

(51) Int. Cl. G03G 15/00

(52) U.S. Cl. 399/82

(57) ABSTRACT

A method of controlling an image forming apparatus supporting glossy printing in a host device, the method including: executing a printer driver of the image forming apparatus; setting a glossy printing option by using a user interface of the executed printer driver; and transmitting printing data and a glossy printing command based on the set glossy printing option to the image forming apparatus for printing the printing data on a printing medium according to the printing data and for performing a fusing operation additionally on a second side that is a reverse side of a first side of the printing medium in accordance with the glossy printing option command, wherein the first side is the latest printed side of the printing medium.

### CROSS-REFERENCE TO RELATED APPLICATIONS

This application claims the benefit of Korean Patent Application No. 10-2009-0077870, filed on Aug. 21, 2009, in the Korean Intellectual Property Office, the disclosure of which is incorporated herein in its entirety by reference.

### BACKGROUND

1. Field

The present general inventive concept relates to a method of controlling an image forming apparatus supporting glossy printing in a host device, and the host device and the image forming apparatus performing the method.

2. Description of the Related Art

In order to improve the quality of printing, gloss may be formed on a printed portion of a printing medium by an image forming apparatus. In order to form gloss on the printed portion of the printing medium by the image forming apparatus, a printing operation may be performed on a glossy printing medium or using a toner having some degree of gloss. When the printing operation is to be performed on the glossy printing medium, gloss is not provided to the printed portion of the printing medium, and when the printing operation is to be performed using the toner having some degree of gloss, it is inconvenient for a user to install the toner having some degree of gloss. Also, in order to perform glossy printing in the image forming apparatus, the user should manipulate a user interface unit of the image forming apparatus to set options for glossy printing

### SUMMARY

Additional aspects and/or advantages will be set forth in part in the description which follows and, in part, will be apparent from the description, or may be learned by practice of the invention.

The present general inventive concept provides a method of controlling an image forming apparatus supporting (or including) glossy printing in a host device, and the host device and the image forming apparatus performing the method.

According to an aspect, there is provided a method of controlling an image forming apparatus supporting glossy printing in a host device, the method including: executing a printer driver of the image forming apparatus; setting a glossy printing option by using a user interface of the executed printer driver; and transmitting printing data and a glossy printing command based on the set glossy printing option to the image forming apparatus for printing the printing data on a printing medium according to the printing data and for performing a fusing operation additionally on a second side that is a reverse side of a first side of the printing medium in accordance with the glossy printing option command, wherein the first side is the latest printed side of the printing medium.

According to another aspect, there is provided a host device connected to an image forming apparatus supporting glossy printing, the host device including: a processor to execute a printer driver of the image forming apparatus; a user interface unit to receive information that is used to set a glossy printing option from a user interface of the executed printer driver; and a communication interface unit to transmit printing data and a glossy printing command to the image forming apparatus, wherein the glossy printing option is in a form of a printer job language (PJL) command.

According to another aspect, there is provided an image forming apparatus supporting glossy printing, the image forming apparatus including: a communication interface unit to receive printing data and/or a glossy printing command from a host device in communication with the image forming apparatus; a controller to determine whether glossy printing is to be performed by using the received printing data and to control an image forming unit and a fusing unit so that a document corresponding to the received printing data is glossy printed; and the image forming unit to print the document corresponding to the received printing data on printing medium when the glossy printing option is set, based on a result of the determination, wherein the image forming unit comprises a fusing unit additionally to perform a fusing operation on a second side that is a reverse side of a printed first side that is the latest printed side of the printing medium on the printing medium according to the set glossy printing option.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 is a block diagram of an image forming system according to an embodiment of the present general inventive concept;

FIG. 2 illustrates a printing option selection screen of a user interface of a printer driver displayed on a host device, according to an embodiment of the present general inventive concept; and

FIG. 3 is a flowchart illustrating a method of controlling an image forming apparatus supporting glossy printing in a host device, according to an embodiment of the present general inventive concept.

### DETAILED DESCRIPTION

Reference will now be made in detail to the embodiments, examples of which are illustrated in the accompanying drawings, wherein like reference numerals refer to the like elements throughout. The embodiments are described below to explain the present invention by referring to the figures.

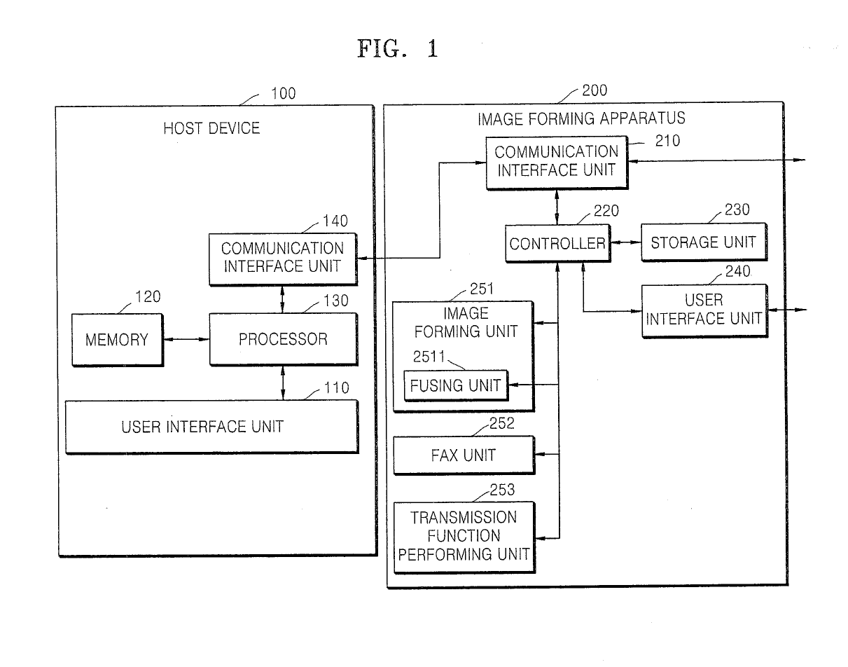

FIG. 1 is a block diagram of an image forming system according to an embodiment. Referring to FIG. 1, the image forming system according to the current embodiment includes a host device 100 and an image forming apparatus 200. The image forming system of FIG. 1 includes one host device 100 and one image forming apparatus 200, but the image forming apparatus 200 may be connected to a plurality of the host devices 100.

In order to prevent features of the embodiment from being overly complicated, only elements related to the embodiment will be described in the preset specification. Thus, it will be understood that general elements other than the elements of FIG. 1 may be further included.

Referring to FIG. 1, the host device 100 includes a user interface unit 110, a memory 120, a processor 130, and a communication interface unit 140. The image forming apparatus 200 includes a communication interface unit 210, a controller 220, a storage unit 230, a user interface unit 240, an image forming unit 251, a fusing unit 2511, a fax unit 252, and a transmission function performing unit 253.

The host device 100 may control the image forming apparatus 200, wherein the image forming apparatus 200 supports glossy printing. The host device 100 may be connected to the image forming apparatus 200 and may be a general computer system or a personal digital assistant (PDA), or more generally, may be any device for controlling the image forming apparatus 200.

The user interface unit 110 may obtain input information from a user and may display output information for the user. For example, when the host device 100 is a general computer system, the user interface unit 110 may include all input/output devices such as a mouse, a keyboard, a monitor, and a speaker.

The user may manipulate the user interface unit 110 to select a document to be printed and to set printing options for printing the selected document. In order to set printing options, the user selects a document to be printed by executing an application in the host device 100. In detail, the user executes the application, opens the document to be printed by the image forming apparatus 200, and executes a printer driver installed in the host device (not shown) for performing a printing operation to set printing options.

The user may execute the printer driver by clicking a printing icon. In other words, when the user selects a printing menu via the user interface unit 110, the processor 130 executes the printer driver. The processor 130 executes the printer driver according to the user's selection, and the executed printer driver displays a user interface screen for setting printing options on the user interface unit 110.

The printer driver may be stored as a program in the memory 120. Also, the memory 120 may further include a program memory (not shown) and a data memory (not shown). Programs for controlling general operations of the host device 100 are stored in the program memory. Data generated when the programs are executed are temporarily stored in the data memory.

The processor 130 controls overall functions of the host device 100. The processor 130 may execute the printer driver. The printer driver is software for performing communication between the host device 100 and the image forming apparatus 200 and is installed in the host device 100 connected to the image forming apparatus 200. The printer driver may control the image forming apparatus 200 and may generate commands for controlling a series of operations of the image forming apparatus 200 to form gloss on (a printed portion of) printing medium. Here the printing medium may include paper, OHP (OverHead Projector) film, etc. The user may install the printer driver in the host device 100 and may control the image forming apparatus 200 by the installed printer driver.

The printer driver installed in the host device 100 may generate printing data for the image forming apparatus 200 to use in printing a printing material. In other words, the printer driver may convert an object to be printed that is generated by executing the application of the host device 100 into data that may be interpreted by the image forming apparatus 200, thereby generating printing data.

For example, examples of the printer driver may include a graphic device interface (GDI) driver, a postscript driver, and a printer command language (PCL) driver.

Also, the processor 130 may receive, from among a plurality of printing options, a selection of printing options for forming gloss on a printed portion of a printing medium, which may be input via the user interface of the executed printer driver. The user may set printing options for controlling the image forming apparatus 200 via the user interface displayed on the user interface unit 110 of the host device 100, e.g., displayed on a display.

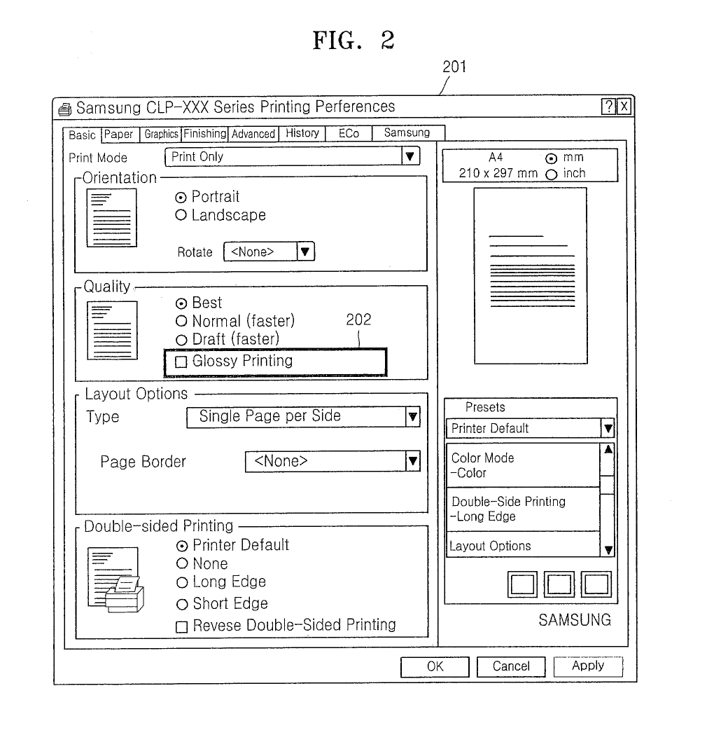

FIG. 2 illustrates a printing option selection screen 201 of a user interface of the printer driver, which is displayed on the host device 100, according to an embodiment. Referring to FIG. 2, when the user selects a “Glossy Printing” check box 202 in order to form a glossy image on a printed portion of a printing medium by the image forming apparatus 200, the processor 130 executes the printer driver, and via the executed printer driver, generates commands for controlling a series of operations of the image forming apparatus 200 to form gloss on a printed portion of a printing medium.

In this case, when a glossy printing option is set, information that indicates that printing medium is to be additionally fused may be displayed on the printing option selection screen 201. For example, when the image forming apparatus 200 supports double-sided printing, the phrase “Printing medium will be additionally fused” is displayed on the printing option selection screen 201, and when the image forming apparatus 200 does not support double-side printing, the phrase “Printing medium will be additionally fused. Please resupply discharged paper” may be further displayed on the printing option selection screen 201. Also, a phrase that indicates that glossy printing is being performed by the image forming apparatus 200 may be displayed on the printing option selection screen 201.

In other words, when the user selects the glossy printing option by using the host device 100, the processor 130, by executing the printer driver, generates commands for performing glossy printing. Thus, the user may set printing options for performing glossy printing by the host device 100.

Referring to FIG. 1, the communication interface unit 140 may transmit the commands that are generated by executing the printer driver and printing data of a document to be printed to the image forming apparatus 200. In other words, the communication interface unit 140 transmits printing data of a document to be printed to the image forming apparatus 200, wherein the glossy printing option command is added to the printing data. The communication interface unit 140 may include any transmission unit that may transmit and receive data between the host device 100 and the image forming apparatus 200.

The communication interface unit 140 may transmit and receive data by using a local unit or via a network. For example, the local unit may be a universal serial bus (USB), etc.

The network according to the current embodiment may include both a wired network manner and a wireless network. Also, examples of the network may include the Internet, a local area network (LAN), a wireless LAN (WLAN), and a wide area network (WAN). However, the present general inventive concept is not limited to this, and it will be understood that any other type of network through which information may be transmitted and received may be used.

Thus, the host device 100 may set the glossy printing option by executing the printer driver so that glossy printing may be performed by the image forming apparatus 200.

Glossy printing is a printing method of forming gloss on a printed portion of a printing material to be printed (such as printing medium) by the image forming apparatus 200. For example, in the image forming apparatus 200 for forming an image by using a toner, degree of gloss of the printing portion of the printing material is controlled by content of wax contained in the toner. Examples of toners according to the content of wax that is used to form gloss include a matt toner having almost no degree of gloss, a high-glossy toner having a high degree of gloss, and a semi-glossy toner having a medium degree of gloss. The toner having a degree of gloss is usually more expensive than the toner having no degree of gloss. In addition, if the user wants glossy printing, the user needs to replace the toner having a degree of gloss. In order to prevent inconvenience due to replacing toner and in order to reduce use of a relatively high-priced toner having a high degree of gloss, in the embodiment, the printer driver of the host device 100 controls the image forming apparatus 200 so that glossy printing may be performed.

The processor 130 may obtain printing data information about whether gloss is to be formed on a printing material (on paper) by using the printer driver. The information may be input via the user interface unit 110. In other words, as described in FIG. 2, the user may input information that is used to form gloss on a printing material by selecting the “Glossy Printing” check box 202 by using the user interface unit 110.

The processor 130 may generate commands for forming gloss on a printed (or whole) portion of a printing material (on paper) to be printed by referring to the obtained information by using the printer driver. In this case, the commands may be in the form of a printer language. Hereinafter, for convenience of explanation, the printer driver as a PCL driver will be described. The PCL driver supports printer job language (PJL).

When the user selects the glossy printing option, the processor 130 may obtain selection information from the printer driver and generates glossy printing commands by referring to the obtained information. The glossy printing commands may be defined in the form of “@PJL SET GLOSSYPRINTING=ON”. In other words, when the glossy printing option is set, the processor 130 sets “@PJL SET GLOSSYPRINTING” to “ON” by using the printer driver, and when the glossy printing option is not set, the processor 130 sets “@PJL SET GLOSSYPRINTING” to “OFF” by using the printer driver or blanks the PJL commands.

The above-described commands are generated in the form of PJL. Generating of the commands in the current embodiment is not limited thereto, and the commands may be generated in various other ways for performing the above function by using various other printer languages.

When the glossy printing option is set by using the printer driver, the processor 130 generates commands for determining whether gloss is to be formed on a printing portion of a document that double-sided printing is to be performed on, in which a printing operation is to be performed on both sides of printing medium, by the image printing apparatus 200. Double-sided printing performs a printing operation on a first side of printing medium and on a second side of the printing medium that is opposite to the first side and is referred to as duplex printing. Single-sided printing, in contrast to double-sided printing, is a printing operation performed on only one side of printing medium and is referred to as simplex printing.

The processor 130 may execute the printer driver to generate commands for the image forming apparatus 200 to perform a double-sided printing operation so as to form gloss on a printed portion of a printing material to be printed by using a double-sided printing process.

The processor 130 may perform a double sided printing operation on the first and second sides of the printing medium according to the commands generated by executing the printer driver and may generate commands for performing a fusing operation (only) on the second side of the printing medium. In this case, the processor 130 generates command for performing an fusing operation on the second side of the printing medium.

Also, the processor 130 may perform a printing operation on the first and second sides of the printing medium according to the commands generated by executing the printer driver and may generate commands for performing a fusing operation (only) on the first side that is a reverse side of the second side that is the (latest) printed on the printing medium. In this case, the processor 130 may generate commands for performing fusing operation on the second side that is the (latest) printed without reversing the printing medium.

In this case, in order to perform the fusing operation, the printing medium is fed along a path of double-sided printing according to the double-sided printing process.

Also, the processor 130 may generate commands for changing the order of printing of printing data due to the additional fusing operation. For example, when performing the double-sided printing process by using the printer driver and performing a printing operation on pieces of printing medium, the processor 130 may generate commands for storing printing data for a following piece of printing medium while performing the additional fusing operation on a current piece of printing medium. In other words, when pages 1 to 4 of a document are to be printed on two pieces of printing medium, the processor 130 may generate commands for performing the additional fusing operation on the piece of printing medium on which a printing operation of the pages 1 and 2 is performed while printing data about the page 3 or 4 are temporarily stored in the image forming apparatus 200.

The fusing operation is additionally performed on the printing medium so that gloss may be formed on the printed portion of the printing material (or paper) by using a toner in which wax is not contained. Also, when the user selects the glossy printing option by using the user interface unit 110 of the host device 100, the printing material (or paper) on which gloss is to be formed may be printed without performing any additional operation.

When double-sided printing is not supported by the image forming apparatus 200, the processor 130 may execute the printer driver for performing a glossy printing, and generate commands for performing an additional fusing operation on the resupplied printing medium, which is discharged form the image forming apparatus 200, by the user.

Thus, the glossy printing may be performed regardless of whether the image forming apparatus 200 supports the double-sided printing or not, by using the printer driver installed in the host device 100.

When double-sided printing is supported by the image forming apparatus 200 by using the printer driver and the size of the printing medium is not proper to perform double-sided printing, the processor 130 may generate commands for performing the additional fusing operation on the printing medium resupplied by the user and may provide gloss to the printed portion of the printing material (or paper) by the image forming apparatus 200.

For example, when the glossy printing option is selected by the user for printing medium having the size of A3 the image forming apparatus 200, the processor 130 performs a single-sided printing process on the printing medium by using the printer driver and generates commands for performing an additional fusing operation on the printing medium resupplied by the user so that gloss may be formed on the printed portion (or whole portion) the printing medium having the size of A3.

Thus, gloss may be provided to the printing portion of the printing material (or printing medium) by setting the glossy printing option regardless of the size of the printing medium by the image forming apparatus 200.

The image forming apparatus 200 is connected to at least one host device 100 in a via wired or wireless network and supports at least one or more functions from among functions such as a printing operation, a scanning operation, a copying operation, a fax sending and receiving operation, an email sending operation, and a data transmission operation to a server (not shown).

The communication interface unit 210 receives at least one of printing data that represents a document to be printed and information that represents a printing option from the host device 100 by using a local unit or via a network. The communication interface unit 210 includes a modem used in fax sending and receiving, a network module for connection with a network, and a USB host module for forming a data moving channel with a mobile storage medium.

As described in the host device 100, the communication interface unit 210 receives commands of the printer driver of the host device 100 that controls a series of operations of the image forming apparatus 200. Also, the communication interface unit 210 receives printing data for printing an image.

The controller 220 may control overall functions of the image forming apparatus 200. In other words, the controller 220 controls the communication interface unit 210, the storage unit 230, the user interface unit 240, the image forming unit 251, the fusing unit 2511, the fax unit 252, and the transmission function performing unit 253.

The controller 220 may execute emulation for setting a printing environment of the document while communicating with the printer driver. In this case, a program that constitutes emulation may be stored in the storage unit 230. Emulation may set the printing environment of the document while communicating with the printer driver in the image forming apparatus 200. In other words, emulation may set the printing environment of the document by referring to commands of the printer driver that are received by the communication interface unit 210.

The controller 220 may determine whether glossy printing is to be performed by using the printing data received from the host device 100 and controls the image forming unit 251 and the fusing unit 2511 so that the printing data may be glossy printed.

When the glossy printing operation is set according to the result of the determination and double-sided printing is supported by the image forming apparatus 200, the controller 220 controls the image forming unit 251 and the fusing unit 2511, wherein the image forming unit 251 performs a printing process on printing medium according to the double-sided printing process, and the fusing unit 2511 performs an additional fusing operation on the printing medium.

When double-sided printing is supported by the image forming apparatus 200, if the printing medium discharged from the image forming apparatus 200 is resupplied by the user, the controller 220 controls the fusing unit 2511 to additionally perform the fusing operation on the resupplied printing medium.

Also, when double-sided printing does not support the size of the printing medium, if printing medium discharged from the image forming apparatus 200 is resupplied by the user, the controller 220 controls the fusing unit 2511 to additionally perform the fusing operation on the resupplied printing medium.

The storage unit 230 is a general storage medium, and it is understood that the storage unit 230 may include any one of a hard disk drive (HDD), a random access memory (RAM), a flash memory, or a memory card or combination thereof.

The user interfaced unit 240 obtains input information input by the user and displays output information for the user. For example, the user interface unit 240 may include any input/output devices such as a display panel, a mouse, a keyboard, a touch screen, a monitor, and a speaker that are disposed in the image forming apparatus 200.

The user interface unit 240 may display that the printing medium will be additionally fused. As described in the image forming apparatus 100, the phrase “Printing medium will be additionally fused. Please resupply discharged paper” may be displayed on the user interface unit 240, or the phrase may be output as a voice to the user. Also, a phrase that indicates that glossy printing is being printed by the image forming apparatus 200 may be displayed on the user interface unit 240.

The image forming unit 251 prints a document corresponding to printing data on the printing medium based on the result of determination of the controller 220. In other words, the image forming unit 251 performs an image forming operation by referring to commands of the printer driver that are received from the host device 100 in relation to the document to be printed according to control of the controller 220.

The image forming unit 251 includes a fusing unit 2511 that may perform at least one a glossy printing option and a fusing operation. The fusing unit 2511 performs an additional fusing operation on a second side of the printing medium that is a reverse side of a first side that is the latest printed on the printing medium.

In other words, when the glossy printing option is set, if a general printing operation is to be performed by the image forming unit 251 of the image forming apparatus 200, the fusing unit 2511 performs an additional fusing operation on the path of double-sided printing or on the printing medium resupplied to a duplex printer by the user.

In this case, the additional fusing operation may be performed on the second side that is a reverse side of the first side that is the latest printed on the printing medium, or the additional fusing operation may be performed on the first side that is the latest printed on the printing medium while the printing medium is not reversed.

When the additional fusing operation is to be performed by the fusing unit 2511, the controller 220 temporarily stops units for performing other operations included in the image forming unit 251 (e.g., a rest state). Also, when a printing operation is to be performed on pieces of printing medium as described above, if the additional fusing operation is performed on printing medium, printing data of a following document to be printed may be temporarily stored in the storage unit 230. Thus, in order to perform the glossy printing option, the controller 220 may change the order of printing of the printing data. In other words, in a general double-sided printing process, a back side of printing medium is firstly printed and then a front side thereof is printed, however, if the glossy printing option is set, the controller 220 may change the order of printing so that the front side of printing medium may be firstly printed and then the back side thereof may be printed. Also, as described above, the printing data is temporarily stored in the storage unit 230 so that the order of printing of the printing data may be changed.

The fax unit 252 and the transmission function performing unit 253 may perform various functions in the image forming apparatus 200. The fax unit 252 performs a fax transmission operation of a document, and the transmission function performing unit 253 may perform an operation of transmitting the document to an external device such as a server, a mobile storage medium, or a computer system.

Examples of the image forming apparatus 100 according to the embodiment include any device that may perform a fusing operation, such as a color multi-path laser printer, a monolator printer, a color single path laser printer, a multifunction peripheral, or an inkjet printer.

Thus, gloss may be formed on the printed portion of the printing medium using the commands generated by the printer driver of the host device 100 without changing the structure of the image forming apparatus 200.

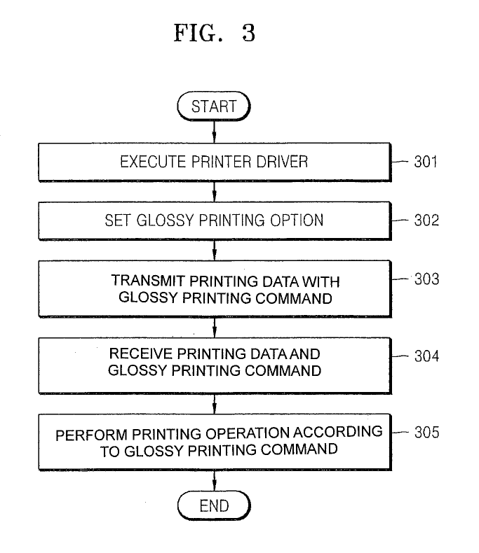

FIG. 3 is a flowchart illustrating a method of controlling the image forming apparatus 200 supporting glossy printing in the host device 100, according to an embodiment of the present general inventive concept. Referring to FIG. 3, the method of controlling the image forming apparatus 200 supporting glossy printing in the host device 100 according to the embodiment includes time sequential operations to be performed in the image forming system of FIG. 1, in a time sequential. Thus, although there are contents omitted, contents described in relation to the image forming system of FIG. 1 also apply to the flowchart of FIG. 3.

In Operation 301, the processor 130 of the host device 100 executes the printer driver.

In Operation 302, the user sets a glossy printing option via the user interface unit 110. The processor 130 generates commands for controlling a series of operations of the image forming apparatus 200 so as to form gloss on a printed portion of a printing medium. For example, the commands may be generated in the form of “@PJL SET GLOSSYPRINTING=ON”.

In Operation 303, the communication interface unit 140 transmits printing data with a glossy printing command based on the set glossy printing option the glossy printing option to the image forming apparatus 200.

In Operation 304, the communication interface unit 210 of the image forming apparatus 200 receives the printing data to which the glossy printing option is added. In other words, the communication interface unit 210 receives commands of the printer driver of the host device 100 for controlling a series of operations of the image forming apparatus 200 so as to form gloss on the printed portion of printing medium.

In Operation 305, the image forming unit 251 prints a document corresponding to printing data on printing medium according to the glossy printing option command, and the fusing unit 2511 performs an additional fusing operation on a second side that is a reverse side of a first side that is the latest printed on the printing medium.

Thus, gloss may be formed on the printing portion of the printed paper by using the printer driver installed in the host device 100. That is, the printing medium to which gloss is provided may be printed while using a toner in which wax is not contained, without adding new hardware elements to the image forming apparatus 200.

The computer readable code can be recorded/transferred on a medium in a variety of ways, with examples of the medium including recording media, such as magnetic storage media (e.g., ROM, floppy disks, hard disks, etc.) and optical recording media (e.g., CD-ROMs, or DVDs).

As described above, according to the embodiments, gloss may be formed on a printing portion of a printing material to be printed by an image forming apparatus 200 conveniently by using a printer driver executed in a host device 100. Thus, gloss may be formed on the printed portion of the printing material by the image forming apparatus 200 without adding new hardware elements to the image forming apparatus.

Although a few embodiments have been shown and described, it would be appreciated by those skilled in the art that changes may be made in these embodiments without departing from the principles and spirit of the invention, the scope of which is defined in the claims and their equivalents.

What is claimed is:

1. A method of controlling an image forming apparatus supporting glossy printing in a host device, the method comprising:
executing a printer driver of the image forming apparatus;
setting a glossy printing option by using a user interface of the executed printer driver; and
transmitting printing data and a glossy printing command based on the set glossy printing option to the image forming apparatus for printing the printing data on a printing medium according to the printing data and for performing a fusing operation additionally on a second side that is a reverse side of a first side of the printing medium in accordance with the glossy printing option command,
wherein the first side is the latest printed side of the printing medium.

2. The method of claim 1, wherein, when the image forming apparatus supports double-sided printing, the second side of the printing medium is fed along a path of double-sided printing.

3. The method of claim 1, wherein, when the image forming apparatus does not support double-sided printing, the printing medium discharged from the image forming apparatus is resupplied by the user

4. The method of claim 3, wherein only the fusing operation is additionally performed on the resupplied printing medium.

5. The method of claim 1, wherein an order of printing of the printing data is changeable due to the additional fusing operation.

6. The method of claim 1, according to the glossy printing option, further comprising displaying that the printing medium is to be additionally fused, wherein the displaying is performed by any one of a user interface unit of the image forming apparatus and a user interface unit of the host device.

7. The method of claim 1, wherein the printing of the document comprises additionally fusing the latest printed first side without reversing printing medium.

8. The method of claim 1, wherein the glossy printing option is in a form of a printer job language (PJL) command.

9. A host device connected to an image forming apparatus supporting glossy printing, the host device comprising:
a processor to execute a printer driver of the image forming apparatus;
a user interface unit to receive information that is used to set a glossy printing option from a user interface of the executed printer driver; and
a communication interface unit to transmit printing data and a glossy printing command to the image forming apparatus,
wherein the glossy printing option is in a form of a printer job language (PJL) command.

10. The host device of claim 9, wherein the user interface unit displays, according to the glossy printing option, that printing medium is to be additionally fused.

11. The host device of claim 9, wherein the glossy printing option allows a first side of the printing medium that is the latest printed or a second side that is a reverse side of the first side to be additionally fused.

12. An image forming apparatus supporting glossy printing, the image forming apparatus comprising:
a communication interface unit to receive printing data and/or a glossy printing command from a host device in communication with the image forming apparatus;
a controller to determine whether glossy printing is to be performed by using the received printing data and to control an image forming unit and a fusing unit so that a document corresponding to the received printing data is glossy printed; and
the image forming unit to print the document corresponding to the received printing data on printing medium when the glossy printing option is set, based on a result of the determination,
wherein the image forming unit comprises a fusing unit additionally to perform a fusing operation on a second side that is a reverse side of a printed first side that is the latest printed side of the printing medium on the printing medium according to the set glossy printing option.

13. The apparatus of claim 12, wherein, when the image forming apparatus supports double-sided printing, the second side of the printing medium is fed along a path of double-sided printing.

14. The apparatus of claim 12, wherein, when the image forming apparatus does not support double-sided printing, the printing medium discharged from the image forming apparatus is resupplied by the user.

15. The apparatus of claim 14, wherein only the fusing operation is additionally performed on the resupplied printing medium.

16. The apparatus of claim 12, wherein an order of printing of the printing data is changeable due to the additional fusing operation.

17. The apparatus of claim 12, further comprising a user interface unit displaying, according to the glossy printing option, that the printing medium is to be additionally fused.

18. The apparatus of claim 12, wherein the fusing unit additionally fuses the latest printed first side without reversing the printing medium.

19. The apparatus of claim 12, wherein the communication interface unit comprises to receive the printing data and/or the glossy printing command through a universal serial bus.

20. The apparatus of claim 12, wherein the host device is in communication with the image forming apparatus via a wired or a wireless network.
